(19) United States
(12) Patent Application Publication
(10) Pub. No.: US 2025/0375707 A1
(43) Pub. Date: Dec. 11, 2025

(54) INTERACTION PROCESSING FOR VIRTUAL SCENE

(71) Applicant: TENCENT TECHNOLOGY (SHENZHEN) COMPANY LIMITED, Shenzhen (CN)

(72) Inventor: Peng LU, Shenzhen (CN)

(73) Assignee: TENCENT TECHNOLOGY (SHENZHEN) COMPANY LIMITED, Shenzhen (CN)

(21) Appl. No.: 19/310,523

(22) Filed: Aug. 26, 2025

Related U.S. Application Data
(63) Continuation of application No. PCT/CN2024/085975, filed on Apr. 3, 2024.

(30) Foreign Application Priority Data
Jun. 9, 2023 (CN) 202310683185.X

(51) Int. Cl. A63F 13/55; A63F 13/52; A63F 13/533

(52) U.S. Cl. CPC A63F 13/55; A63F 13/52; A63F 13/533

(57) ABSTRACT

In an interaction processing method for a virtual scene, the virtual scene and a graphical user interface are displayed. The virtual scene includes a non-player character (NPC) and a virtual character of a turn-based game. Notification information that includes NPC skill information associated with an NPC skill of the NPC that is to be performed in a next turn of the NPC in the turn-based game is displayed. The notification information is displayed during a turn of the virtual character that precedes the next turn of the NPC and in which a skill triggering operation for the virtual character is to be performed by a user. The virtual character is controlled to perform a triggered skill based on the skill triggering operation for the virtual character. Apparatus and non-transitory computer-readable storage medium counterpart embodiments are also contemplated.

### RELATED APPLICATIONS

The present application is a continuation of International Application No. PCT/CN2024/085975, filed on Apr. 3, 2024, which claims priority to Chinese Patent Application No. 202310683185.X, filed on Jun. 9, 2023. The entire disclosures of the prior applications are hereby incorporated by reference.

### FIELD OF THE TECHNOLOGY

This application relates to the field of computer technologies, including an interaction processing method for a virtual scene.

### BACKGROUND OF THE DISCLOSURE

Through display technology based on graphics processing hardware, the ways in which people perceive their environment and obtain information are expanded. In particular, display technology for virtual scenes enables diverse interactions between virtual objects, which can be controlled by users or artificial intelligence (AI) based on actual application requirements. This technology has a variety of typical application scenarios. For example, it can simulate real battles between virtual objects in a virtual scene of a game.

In a virtual scene of a game, various forms of battle can occur between virtual objects, and non-player characters (NPCs) possess a wide range of skills. Therefore, it is difficult for a player to predict NPC actions. Players often respond by adopting conservative strategies for their own characters, which leads to inefficient interactions between player characters (PCs) and NPCs. This inefficiency can reduce experience and interest of the player in the game.

Currently, no good solution to a problem of low interaction efficiency in the virtual scene exists in related art.

### SUMMARY

Aspects of this disclosure include a method, an apparatus, and a non-transitory computer-readable storage medium for interaction processing for a virtual scene, so that a human-computer interaction mode of the virtual scene can be enriched, which can improve human-computer interaction efficiency.

Examples of technical solutions of this disclosure may be implemented as follows:

An aspect of this disclosure provides an interaction processing method for a virtual scene. The virtual scene and a graphical user interface are displayed. The virtual scene includes a non-player character (NPC) and a virtual character of a turn-based game. Notification information that includes NPC skill information associated with an NPC skill of the NPC that is to be performed in a next turn of the NPC in the turn-based game is displayed. The notification information is displayed during a turn of the virtual character that precedes the next turn of the NPC and in which a skill triggering operation for the virtual character is to be performed by a user. The virtual character is controlled to perform a triggered skill based on the skill triggering operation for the virtual character.

An aspect of this disclosure provides an interaction processing apparatus for a virtual scene, The apparatus includes processing circuitry configured to display the virtual scene and a graphical user interface. The virtual scene includes a non-player character (NPC) and a virtual character of a turn-based game. The processing circuitry is configured to display notification information that includes NPC skill information associated with an NPC skill of the NPC that is to be performed in a next turn of the NPC in the turn-based game. The notification information is displayed during a turn of the virtual character that precedes the next turn of the NPC and in which a skill triggering operation for the virtual character is to be performed by a user. The processing circuitry is configured to control the virtual character to perform a triggered skill based on the skill triggering operation for the virtual character.

An aspect of this disclosure provides an interaction processing method for a virtual scene, the method being performed by an electronic device, and including: displaying a virtual scene on a human-computer interaction interface, the virtual scene including a non-player character (NPC) and a player character (PC) that interact in a round-based manner; displaying prompt information related to a to-be-released skill of the NPC in response to currently being in a process of waiting to receive a skill triggering operation for the PC; and controlling, in response to the skill triggering operation for the PC, the PC to release a skill triggered by the skill triggering operation, the prompt information being used as reference information of the skill triggering operation.

An aspect of this disclosure provides an interaction processing apparatus for a virtual scene, including: a display module, configured to display a virtual scene on a human-computer interaction interface, the virtual scene including an NPC and a PC that interact in a round-based manner; the display module being configured to display prompt information related to a to-be-released skill of the NPC in response to currently being in a process of waiting to receive a skill triggering operation for the PC; and a skill release module, configured to control, in response to the skill triggering operation for the PC, the PC to release a skill triggered by the skill triggering operation, the prompt information being used as reference information of the skill triggering operation.

An aspect of this disclosure provides an electronic device, including: a memory, configured to store a computer-executable instruction; and a processor, configured to implement the interaction processing method for a virtual scene provided in the aspects of this disclosure when executing the computer-executable instruction stored in the memory.

An aspect of this disclosure provides a non-transitory computer-readable storage medium, having a computer-executable instruction stored therein, the computer-executable instruction, when executed by a processor, cause the processor to implement the interaction processing method for a virtual scene provided in the aspects of this disclosure.

An aspect of this disclosure provides a computer program product, including a computer program or a computer-executable instruction, the computer program or the computer-executable instruction, when executed by a processor, implementing the interaction processing method for a virtual scene provided in the aspects of this disclosure.

Aspects of this disclosure have the following beneficial effects.

During the interaction between the NPC and the PC in a round-based manner, before the player releases a skill, prompt information related to a to-be-released skill of the NPC is displayed, and the prompt information is used as reference information for the PC to release the skill, so that the player decides the skill to be released by the PC, which enriches a human-computer interaction mode of a virtual scene, improves interaction efficiency in the virtual scene, saves computing resources required by the virtual scene, reduces the operation difficulty of the user, and then improves user experience.

### BRIEF DESCRIPTION OF THE DRAWINGS

FIG. 1A is a schematic diagram of a first application mode of an interaction processing method for a virtual scene according to an aspect of this disclosure.

FIG. 1B is a schematic diagram of a second application mode of an interaction processing method for a virtual scene according to an aspect of this disclosure.

FIG. 2 is a schematic structural diagram of an electronic device according to an aspect of this disclosure.

FIG. 3A is a first schematic flowchart of an interaction processing method for a virtual scene according to an aspect of this disclosure.

FIG. 3B is a second schematic flowchart of an interaction processing method for a virtual scene according to an aspect of this disclosure.

FIG. 3C is a third schematic flowchart of an interaction processing method for a virtual scene according to an aspect of this disclosure.

FIG. 3D is a fourth schematic flowchart of an interaction processing method for a virtual scene according to an aspect of this disclosure.

FIG. 4A is a first schematic diagram of a human-computer interaction interface according to an aspect of this disclosure.

FIG. 4B is a second schematic diagram of a human-computer interaction interface according to an aspect of this disclosure.

FIG. 4C is a third schematic diagram of a human-computer interaction interface according to an aspect of this disclosure.

FIG. 4D is a fourth schematic diagram of a human-computer interaction interface according to an aspect of this disclosure.

FIG. 4E is a fifth schematic diagram of a human-computer interaction interface according to an aspect of this disclosure.

FIG. 4F is a sixth schematic diagram of a human-computer interaction interface according to an aspect of this disclosure.

FIG. 4G is a seventh schematic diagram of a human-computer interaction interface according to an aspect of this disclosure.

FIG. 4H is an eighth schematic diagram of a human-computer interaction interface according to an aspect of this disclosure.

FIG. 4I is a ninth schematic diagram of a human-computer interaction interface according to an aspect of this disclosure.

FIG. 5 is a schematic diagram of icons of skills according to an aspect of this disclosure.

FIG. 6 is a fifth schematic flowchart of an interaction processing method for a virtual scene according to an aspect of this disclosure.

FIG. 7 is a schematic diagram of a behavior tree according to an aspect of this disclosure.

### DETAIL DESCRIPTION

To make objectives, technical solutions, and advantages of this disclosure clearer, this disclosure is to be further described in further detail with reference to accompany drawings. The described aspects are not to be construed as a limitation on this disclosure. All other aspects obtained by a person of ordinary skill in the art fall within the scope of this disclosure. In the following description, the involved expression “some aspects” describes subsets of all possible aspects, but the expression “some aspects” may be the same subset or different subsets of all the possible aspects, and may be combined with each other without conflict. Further, the descriptions of the terms are provided as examples only and are not intended to limit the scope of the disclosure.

In the following description, a term “first/second/third” involved is merely configured for distinguishing between similar objects and does not represent a specific order of objects. “First/second/third” may be transposed for a specific order or a sequence when allowed, so that the aspects of this disclosure described herein can be implemented in an order other than those illustrated or described herein.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Unless otherwise defined, meanings of all technical and scientific terms used in this specification are the same as those usually understood by a person skilled in the art to which this disclosure belongs. The terms used in this specification are merely intended to describe examples of the aspects of this disclosure, and are not intended to limit this disclosure.

Before the aspects of this disclosure are further described in further detail, a description is made on nouns and terms in the aspects of this disclosure, and the nouns and terms in the aspects of this disclosure are applicable to the following explanations.

1) Virtual scene: It is a scene different from the real world outputted through a device. Visual perception of the virtual scene can be formed through naked eyes or assistance of a device, for example, a two-dimensional image outputted by a display, and a three-dimensional image outputted through stereoscopic display technologies such as stereoscopic projection, virtual reality, and augmented reality. In addition, various sensations such as auditory perception, haptic perception, olfactory perception, and motion perception that simulate the real world may be further formed through various possible hardware. The virtual scene may be a virtual game scene.

2) In response to: It is configured for indicating a condition or a status on which a performed operation depends. When the condition or the status is satisfied, one or more operations may be performed in real time or with a set delay. Unless otherwise specified, an order in which a plurality of operations are performed is not limited.

3) Virtual object: It is an object that performs interaction in a virtual scene, which is controlled by a user or a robot program (such as an artificial intelligence (AI)-based robot program), and can remain still, move, and perform various behaviors in the virtual scene, for example, various characters in a game. For example, the characters include a user-controlled virtual object, a virtual monster, and a non-player character (NPC).

4) PC: The PC may refer to a character controlled by a player in a game. The PC may be a virtual image configured for representing the player in the virtual scene, for example, a virtual character, a virtual animal, or a cartoon character. The PC has a shape and a volume in the virtual scene, and occupies a part of space of the virtual scene.

5) NPC: The NPC may refer to a character not controlled by a player in a game. The NPC is controlled by AI of a computer, which is a character having its own behavior pattern. NPCs may be divided into plot NPCs, combat NPCs, service NPCs, and the like, and sometimes include an NPC with various functions. The plot NPCs and the service NPCs are usually not attackable objects, or are attackable objects but do not actively attack. In addition, some NPCs may drop props, and may provide some game information for a player, or trigger a plot.

6) Behavior tree: It is a mathematical model of plan execution used in computer science, robotics, control systems, and video games. The behavior tree describes switching between a finite set of tasks in a modular fashion. An advantage of the behavior tree is that a complex task formed by simple tasks can be created without having to worry about how the simple tasks are implemented.

7) Round: In the field of games, a round includes one attack from an enemy and one counterattack from an ally. One round includes two turns, where the enemy performs an interactive behavior in one turn, and the ally performs an interactive behavior in another turn.

8) Player versus environment (PVE): It is a game battle mode, i.e., in a game, a player challenges an NPC monster and a boss that are controlled by a game program. The PVE is sometimes referred to as player vs computer (PVC).

9) Virtual energy: It is energy required for a virtual object to release a game skill in a virtual game scene, for example, a skill point in a game.

10) Game skill: It is a game term, and may refer to an active operation that generates effects such as attack, defense, and assistance in a game. Virtual energy of a virtual object is consumed in a process of using a game skill. Types of the game skill include attack, defense, assistance (which provide a buff for an attribute parameter, for example, acceleration), energy regeneration, health point regeneration, and the like.

11) Regeneration: An increase change of an attribute parameter in the game field may be referred to as regeneration. For example, an increase in a health point may be referred to as health point regeneration.

12) Convolutional neural network (CNN): It is a type of feed forward neural network (FNN) including convolution calculation and having a deep structure, and is one of representative algorithms of deep learning. The CNN has the ability of representation learning, and can perform shift-invariant classification on an input image based on a hierarchical structure thereof.

The aspects of this disclosure provide an interaction processing method for a virtual scene, an interaction processing apparatus for a virtual scene, an electronic device, a computer-readable storage medium, and a computer program product, so that a human-computer interaction mode of the virtual scene can be enriched, thereby improving human-computer interaction efficiency.

An application of the electronic device provided in the aspects of this disclosure is described below. The electronic device provided in the aspects of this disclosure may be implemented as various types of user terminals such as a notebook computer, a tablet computer, a desktop computer, a set-top box, a mobile device (for example, a mobile phone, a portable music player, a personal digital assistant, a dedicated messaging device, or a portable game device), an on-board terminal, a virtual reality (VR) device, and an augmented reality (AR) device, or may be implemented as a server. An application in which a device is implemented as a terminal device or a server is described below.

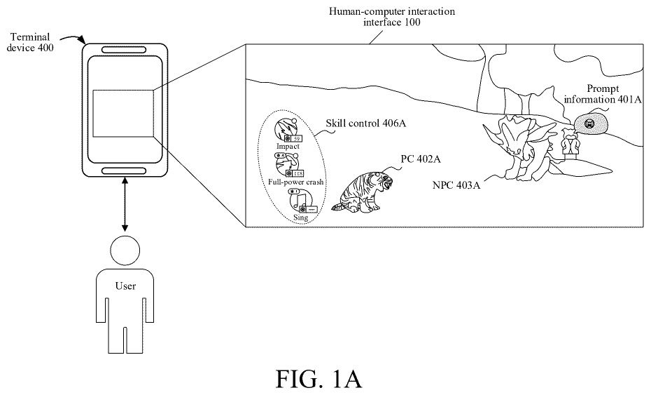

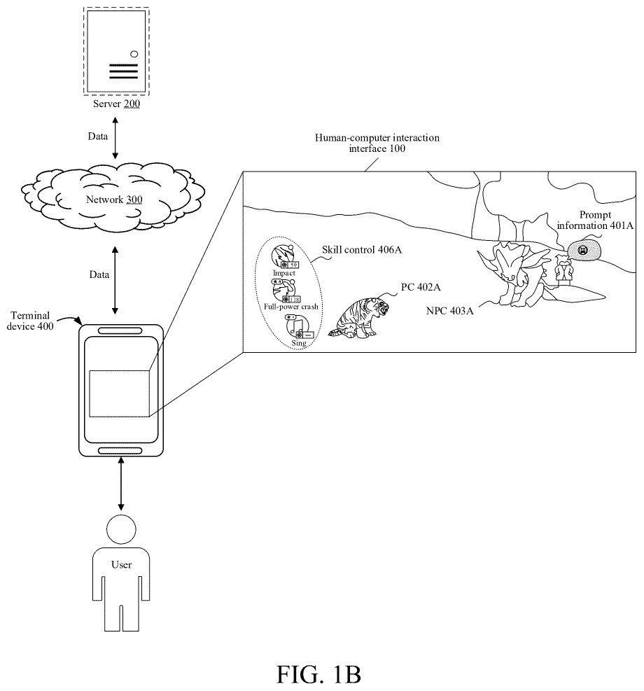

In an implementation scenario, FIG. 1A is a schematic diagram of a first application mode of an interaction processing method for a virtual scene according to an aspect of this disclosure, which is applicable to some application modes of relying on computing power of graphics processing hardware of a terminal device 400 to complete calculation of related data of a virtual scene. For example, in a game in a stand-alone/an off-line mode, outputting of a virtual scene is completed through various different types of terminal devices 400 such as a smart phone, a tablet computer, and a virtual reality/augmented reality device.

In an example, types of graphics processing hardware include a central processing unit (CPU) and a graphics processing unit (GPU).

When visual perception of the virtual scene is formed, the terminal device 400 calculates data required for display through the graphics computing hardware, completes loading, parsing, and rendering of the displayed data, and outputs a video frame capable of forming visual perception of the virtual scene on the graphics output hardware. For example, a two-dimensional video frame is presented on a display screen of a smart phone, or a video frame with a three-dimensional display effect is projected onto lenses of augmented reality/virtual reality glasses. In addition, to enrich the perception effect, the terminal device 400 may further form one or more of auditory perception, tactile perception, motion perception, and taste perception through different hardware.

In an example, a client (for example, a stand-alone game application) is run on the terminal device 400, and a virtual scene including role play is outputted during the running of the client. The virtual scene may be an environment for game characters to interact, which may be a plain, a street, a valley, or the like for game characters to fight, for example. The first virtual object may be a user-controlled game character, i.e., the first virtual object is controlled by a real user and is to move in the virtual scene in response to an operation of the real user performed on a controller (such as a touch screen, a voice-operated switch, a keyboard, a mouse, and a joystick). For example, when the real user moves the joystick to the right, the first virtual object is to move to the right in the virtual scene, or may keep still, jump, and control the first virtual object to perform a shooting operation.

For example, the virtual scene may be a virtual game scene, a user may be a player, a PC is a virtual object controlled by the player, and an NPC may be a virtual object controlled by AI. A description is provided below in combination with the above examples.

For example, a virtual scene is displayed on a human-computer interaction interface 100 in the terminal device 400. When it is the turn of the PC to release a skill, prompt information 401A related to a skill to be released by the NPC in a next round is displayed on the human-computer interaction interface 100 of the terminal device 400. The player may use the prompt information as reference to select a skill, and trigger the skill, so that the PC interacts with the NPC.

Before FIG. 1B is described, a game mode involved in the solution collaboratively implemented by the terminal device and the server is described. The solution collaboratively implemented by the terminal device and the server mainly involves two game modes, which are respectively a local game mode and a cloud game mode. The local game mode means that the terminal device and the server collaboratively run a game processing logic. Some of the operation instructions inputted by the player in the terminal device are processed by terminal device running game logic, and the other part is processed by server running game logic. In addition, the game processing logic run by the server is often more complex and requires more computing power. The cloud game mode means that the game processing logic is run by the server, and a cloud server renders game scene data into an audio/video stream, and transmits the audio/video stream to the terminal device for display through a network. The terminal device only needs to have a basic streaming media playback capability and a capability of obtaining an operation instruction of the player and transmitting the operation instruction to the server.

In another implementation scenario, FIG. 1B is a schematic diagram of a second application mode of an interaction processing method for a virtual scene according to an aspect of this disclosure, which is applied to a terminal device 400 and a server 200, and is applicable to an application mode of relying on computing power of the server 200 to complete calculation of a virtual scene and outputting the virtual scene at the terminal device 400.

Visual perception of the virtual scene being formed is used as an example. The server 200 calculates display data (such as scene data) related to the virtual scene and transmits the data to the terminal device 400 through a network 300. The terminal device 400 relies on graphics computing hardware to complete loading, parsing, and rendering of the calculated display data, and relies on the graphics output hardware to output a virtual scene to form visual perception. For example, a two-dimensional video frame may be presented on a display screen of a smart phone, or a video frame with a three-dimensional display effect is projected onto lenses of augmented reality/virtual reality glasses. For the perception in the form of the virtual scene, a virtual scene may be outputted by means of the corresponding hardware of the terminal device 400, for example, using a microphone to form auditory perception, and using a vibrator to form haptic perception.

In an example, a client (for example, an online game application) is run on the terminal device 400, and a virtual scene including role play is outputted during the running of the client. The virtual scene may be an environment for game characters to interact, which may be a plain, a street, a valley, or the like for game characters to fight, for example. The first virtual object may be a user-controlled game character, i.e., the first virtual object is controlled by a real user and is to move in the virtual scene in response to an operation of the real user performed on a controller (such as a touch screen, a voice-operated switch, a keyboard, a mouse, and a joystick). For example, when the real user moves the joystick to the right, the first virtual object is to move to the right in the virtual scene, or may keep still, jump, and control the first virtual object to perform a shooting operation.

For example, the virtual scene may be a virtual game scene, the server 200 may be a server of a game platform, a user may be a player, a PC is a virtual object controlled by the player, and an NPC may be a virtual object controlled by AI. A description is provided below in combination with the above examples.

For example, the server 200 runs a game process. When it is the turn of the PC to release a skill, the server 200 determines a skill to be released by the NPC in a next round, generates prompt information related to the skill to be released by the NPC in the next round, and transmits the prompt information to the terminal device 400. Prompt information 401A related to a skill to be released by the NPC in a next round is displayed on the human-computer interaction interface 100 of the terminal device 400. The player may use the prompt information as reference to select a skill, and trigger the skill, so that the PC interacts with the NPC.

In some aspects, the terminal device 400 may implement the interaction processing method for a virtual scene provided in this aspect of this disclosure by running a computer program. For example, the computer program may be a native program or a software module in an operating system; or may be a native application (APP), i.e., a program that needs to be installed in the operating system to run, such as a game APP, or may be a mini program that can be embedded into any APP, i.e. a program that only needs to be downloaded into a browser environment to run. In a word, the foregoing computer program may be an APP, a module, or a plug-in of any form.

A computer program being an application program is used as an example. During actual implementation, an application supporting a virtual scene is installed and run in the terminal device 400. The application program may be any one of a first-person shooting game (FPS), a third-person shooting game, a virtual reality application program, a three-dimensional map program, or a multiplayer survival game. A user uses the terminal device 400 to operate a virtual object located in the virtual scene to perform an activity. The activity includes but is not limited to at least one of adjusting a body posture, crawling, walking, running, riding, jumping, driving, pickup, shooting, attacking, throwing, and building a virtual building. For example, the virtual object may be a virtual character, such as a simulated character or a cartoon character.

The aspects of this disclosure may be implemented through a database technology. In short, a database may be regarded as an electronic file cabinet, namely, a place in which electronic files are stored. A user may perform an operation such as adding, querying, updating, or deleting data in a file. The so-called “database” is a data set that is stored together in a certain manner, can be shared with a plurality of users, has as little redundancy as possible, and is independent of an application.

A database management system (DBMS) is a computer software system designed to manage databases, which has basic functions such as storage, interception, security assurance, and backup. The DBMS may be classified based on database models that the DBMS supports, such as a relation and extensible markup language (XML); or classified based on computer types that the DBMS supports, such as a server cluster and a mobile phone; or classified based on a query language used, for example, structured query language (SQL) or XQuery; or classified based on performance impulse focuses, for example, a maximum scale and a maximum running speed; or classified in another classification manner. Regardless of which classification manner is used, some DBMSs can cross categories, for example, support a plurality of query languages simultaneously.

The aspects of this disclosure may be further implemented through a cloud technology. The cloud technology is a general term for a network technology, an information technology, an integration technology, a platform management technology, and an application technology based on application of a cloud computing business model, which may form a resource pool and be used on demand in a flexible and convenient manner. A cloud computing technology is to become an important support. Background services of a technology network system require a lot of computing and storage resources, such as a video website, a picture website, and more portal websites. With the rapid development and application of the Internet industry, and promotion of requirements such as a search service, a social network, mobile commerce, and open collaboration, each item may have its own hash code identification mark in the future, and the hash code identification marks need to be transmitted to a background system for logical processing. Data of different levels is to be processed separately, and all kinds of industry data require a strong system support, which can only be achieved through the cloud computing.

The aspects of this disclosure may further be implemented through AI. AI is a theory, a method, a technology, and an application system that uses a digital computer or a machine controlled by the digital computer to simulate, extend, and expand human intelligence, perceive the environment, acquire knowledge, and use knowledge to obtain an optimal result. In other words, AI is a comprehensive technology in computer science and attempts to understand the essence of intelligence and produce a new intelligent machine that can respond in a manner similar to human intelligence. The AI is to study the design principles and implementation methods of various intelligent machines, to enable the machines to have functions of sensing, reasoning, and decision-making.

The AI technology is a comprehensive discipline, and involves a wide range of fields including both the hardware-level technology and the software-level technology. The basic AI technologies include technologies such as a sensor, a dedicated AI chip, cloud computing, distributed storage, a big data processing technology, a model pre-training technology, an operating/interaction system, and electromechanical integration. A pre-trained model is also referred to as a large model or a basic model, which may be widely applied to downstream tasks in various fields of AI after fine tuning. AI software technologies mainly include several major directions such as a computer vision technology, a speech processing technology, a natural language processing technology, and machine learning/deep learning.

In some aspects, the server in FIG. 1B may be an independent physical server, or may be a server cluster formed by a plurality of physical servers or a distributed system, and may further be a cloud server providing basic cloud computing services such as cloud service, a cloud database, cloud computing, a cloud function, cloud storage, a network service, cloud communication, a middleware service, a domain name service, a security service, a content delivery network (CDN), and a big data and artificial intelligence platform. The electronic device may be a smart phone, a tablet computer, a notebook computer, a desktop computer, a smart speaker, a smart watch, or the like, which is not limited thereto. The terminal and the server may be directly or indirectly connected through wired or wireless communication, which is not limited in the aspects of the present disclosure.

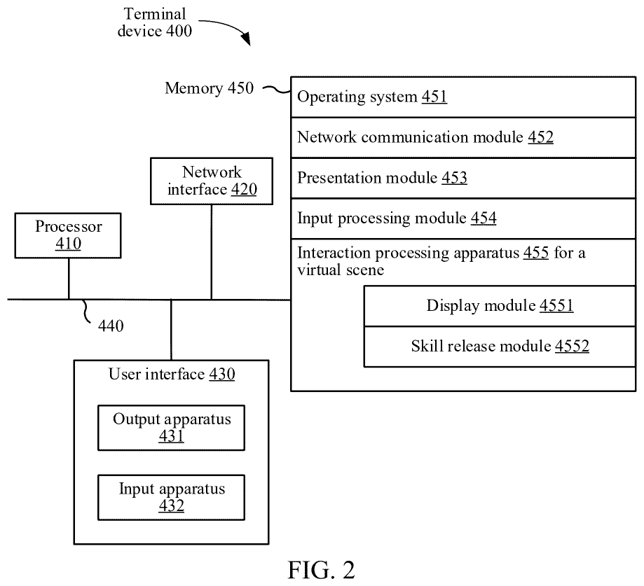

FIG. 2 is a schematic structural diagram of an electronic device according to an aspect of this disclosure. The electronic device may be the terminal device 400 shown in FIG. 1A or FIG. 1B. The terminal device 400 shown in FIG. 2 includes processing circuitry, such as at least one processor 410, a memory 450 (e.g., a non-transitory computer-readable storage medium), at least one network interface 420, and a user interface 430. Various components in the terminal device 400 are coupled together through a bus system 440. The bus system 440 is configured to implement connection and communication between the components. In addition to a data bus, the bus system 440 further includes a power bus, a control bus, and a status signal bus. However, for clarity, various buses are marked as the bus system 440 in FIG. 2.

The processor 410 may be an integrated circuit chip with a signal processing capability, for example, a general-purpose processor, a digital signal processor (DSP), another programmable logic device, a discrete gate or a transistor logic device, or a discrete hardware component. The general-purpose processor may be a microprocessor, any conventional processor, or the like.

The user interface 430 includes one or more output apparatuses 431 that enable presentation of media content, including one or more speakers and/or one or more visual display screens. The user interface 430 further includes one or more input apparatuses 432, including user interface components that facilitate user input, such as a keyboard, a mouse, a microphone, a touch screen display, a camera, and another input button and control.

The memory 450 may be removable, non-removable, or a combination thereof. An hardware device includes a solid-state memory, a hard disk driver, an optical disk driver, and the like. In some aspects, the memory 450 includes one or more storage devices at a physical location away from the processor 410.

The memory 450 includes a volatile memory or a non-volatile memory, or may include both the volatile memory and the non-volatile memory. The non-volatile memory may be a read-only memory (ROM). The volatile memory may be a random access memory (RAM). The memory 450 described in this aspect of this disclosure is intended to include any suitable type of memory.

In some aspects, the memory 450 can store data to support various operations. Examples of the data include a program, a module, and a data structure, or a subset or a superset thereof. A description is provided below.

An operating system 451 includes system programs configured to process various basic system services and perform hardware-related tasks, for example, a frame layer, a core library layer, and a driver layer, which are configured to implement various basic businesses and process hardware-based tasks.

A network communication module 452 is configured to arrive at another electronic device through one or more (wired or wireless) network interfaces 420. For example, network interfaces 420 include a Bluetooth interface, a wireless interface such as a Wi-Fi interface, a universal serial bus (USB) interface, and the like.

A presentation module 453 is configured to enable presentation of information (for example, a user interface for operation of a peripheral device and display of content and information) through one or more output apparatuses 431 (for example, a display screen and a speaker) associated with the user interface 430.

An input processing module 454 is configured to detect one or more user inputs or interactions from one of the one or more input apparatuses 432 and translate the detected inputs or interactions.

In some aspects, an apparatus provided in this aspect of this disclosure may be implemented by software. FIG. 2 shows an interaction processing apparatus 455 for a virtual scene stored in the memory 450, which may be software in the form of programs and plug-ins, including the following software modules: a display module 4551 and a skill release module 4552. The modules are logical and may be combined in different manners to form other aspects based on implemented functions or further split. Functions of the modules are described below.

The interaction processing method for a virtual scene provided in the aspects of this disclosure is described below. As mentioned above, the electronic device that implements the interaction processing method for a virtual scene provided in the aspects of this disclosure may be a terminal device or a combination of the terminal device and a server. Therefore, an execution subject of each operation is not repeatedly described below.

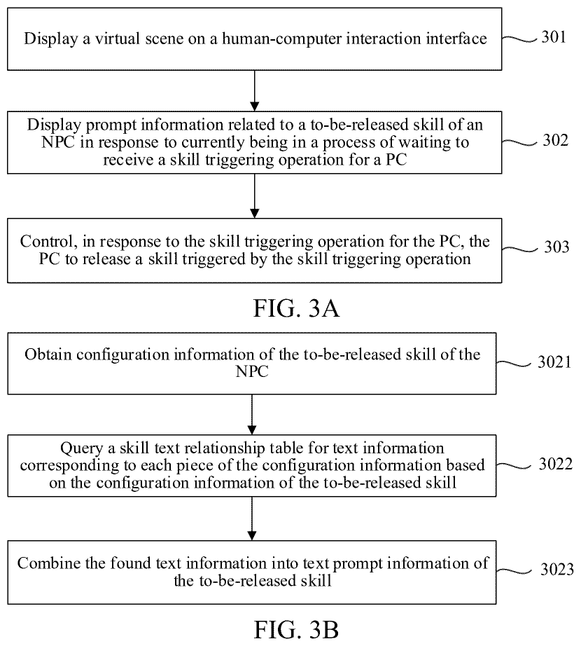

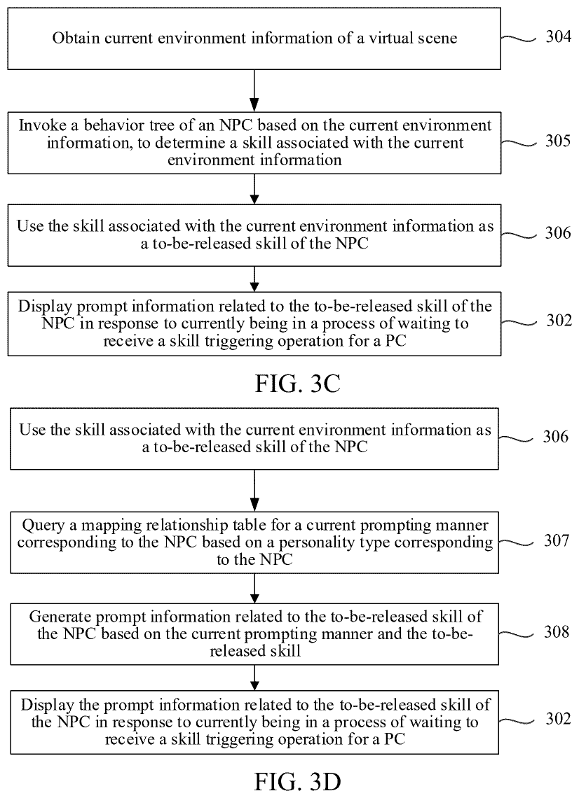

FIG. 3A is a first schematic flowchart of an interaction processing method for a virtual scene according to an aspect of this disclosure. A description is provided based on operations shown in FIG. 3A.

Operation 301: Display a virtual scene on a human-computer interaction interface. For example, the virtual scene and a graphical user interface are displayed. The virtual scene includes a non-player character (NPC) and a virtual character of a turn-based game.

The virtual scene herein includes an NPC and a PC that interact in a round-based manner.

For example, in the field of games, a round includes one interactive behavior from an enemy and an ally. One round includes two turns, where the enemy performs an interactive behavior in one turn, and the ally performs an interactive behavior in another turn. The interactive behavior may be an attack, defense, competition, greeting, and another behavior. The NPC is a virtual object in a virtual scene that is controlled by a server or a terminal device running the virtual scene, and the PC is a virtual object whose behavior is decided by a player.

In some aspects, FIG. 3C is a third schematic flowchart of an interaction processing method for a virtual scene according to an aspect of this disclosure. Before operation 302 in FIG. 3A, a to-be-released skill of the NPC may be obtained by performing operation 304 to operation 306 in FIG. 3C.

In operation 304, current environment information of a virtual scene is obtained. For example, current environment information of the virtual scene is obtained. The current environment information includes at least one of an attribute parameter of the virtual character, a quantity of current rounds, an attribute parameter of the NPC, and a terrain of the virtual scene.

Herein, the current environment information includes at least one of the following: an attribute parameter of the PC, a quantity of current rounds, an attribute parameter of the NPC, and a terrain of the virtual scene.

For example, types of the attribute parameter of the PC include a health point, energy, attack power, a defense value, and a player level. The quantity of current rounds is a sum of a quantity of rounds in which the NPC and the PC have interacted with and 1. For example, if the PC performs an interactive behavior for 4 times, and the NPC performs the interactive behavior for 4 times, the quantity of current rounds is 5, and a current round is a 5^{th} round.

In operation 305, a behavior tree of the NPC is invoked based on the current environment information, to determine a skill associated with the current environment information. For example, a behavior tree of the NPC is invoked based on the current environment information to determine a skill associated with the current environment information. Each leaf node of the behavior tree corresponds to a different skill of the NPC. Each selection node of the behavior tree determines a leaf node corresponding to the current environment information.

Herein, each leaf node of the behavior tree corresponds to a different skill of the NPC, and each selection node of the behavior tree is configured to determine a leaf node corresponding to the current environment information. The behavior tree may further be implemented through a classification model of a neural network model.

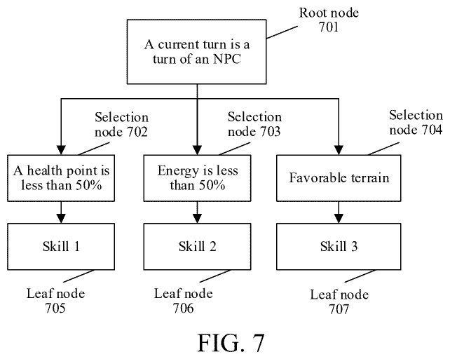

FIG. 7 is a schematic diagram of a behavior tree according to an aspect of this disclosure. A root node 701 starts to determine a skill of an NPC based on current environment information when a current turn is a turn of the NPC. When the current environment information meets that a health point of the NPC is less than 50% of a total health point (a selection node 702), it is determined that an associated skill is a skill 1 (a leaf node 705). When the current environment information meets that energy of the NPC is less than 50% of total energy (a selection node 703), it is determined that the associated skill is a skill 2 (a leaf node 706). When the current environment information meets that a health point of the NPC is less than 50% of a total health point (a selection node 704), it is determined that an associated skill is a skill 3 (a leaf node 707).

Operation 306: Use the skill associated with the current environment information as a to-be-released skill of the NPC. For example, the skill associated with the current environment information is designated as the NPC skill.

For example, the skill associated with the current environment information outputted by the behavior tree is used as the to-be-released skill of the NPC.

In this aspect of this disclosure, the to-be-released skill of the NPC is determined based on the current environment information, and a combat strategy of the NPC is dynamically formulated to enhance a sense of reality of an interactive behavior, which can enrich a human-computer interaction mode of a virtual scene, and improve experience of a player interacting with the NPC.

For example, during a battle of a virtual scene, mutual restraint exists between virtual skills. Skill types include an attack skill, a defense skill, and a status skill. The attack skill is configured for attacking an enemy. The defense skill is configured for defending against an external attack or perform effect attenuation on a status attribute. The status skill is configured for increasing or decreasing an attribute parameter, for example, increasing parameters such as a health point, energy, a speed value, defense power, and attack power of a virtual object using a skill, or reducing a speed value and defense power of an enemy virtual object of a virtual object using a skill.

The defense skill restrains the attack skill, and an effect of the defense skill is to completely or partially offset damage of the attack skill. For example, an attack skill of an NPC may cause a decrease of 150 of a health point, but if the PC uses a defense skill, the attack skill of the NPC only causes a health point of the PC to decrease by 50.

The attack skill restrains the status skill. The attack skill may reduce an attribute parameter increased through the status skill, or the attack skill causes higher damage to a character using the status skill than to a character using another skill. For example, the status skill is configured for increasing a health point thereof. If a character to which the status skill is applied is attacked through an attack skill, an increased health point of the character eventually decreases.

The status skill restrains the defense skill. The status skill may increase an attribute parameter. After the status skill is used, a character can cause more damage to the defense skill of another character. For example, the status skill is configured for increasing attack power. Therefore, a character with increased attack power attacks another character using a defense skill, and can cause higher damage than a character whose attack power has not increased.

For example, it is assumed that a first turn and a second turn belong to one round, and the first turn precedes the second turn. It is assumed that a combat ends until one of an enemy and an ally wins, the combat includes a plurality of rounds, a PC releases a skill in a first turn, and an NPC releases a skill in a second turn. Alternatively, the PC releases a skill in a second turn, and the NPC releases a skill in a first turn.

In some aspects, a sequence in which the PC and the NPC release skills in each round may be determined in any of the following manners. Attribute parameters (for example, an agility value and a speed value) for speed representation of the PC and the NPC are obtained, and a character with a larger attribute parameter for speed representation is used as the first character to release a skill.

For example, if an agility value of a PC is less than that of an NPC, prompt information is displayed at the beginning of one round, and the player selects a skill released by the PC. In a combat animation, the NPC first releases a skill, and the PC then releases a skill. If the agility values of the two characters do not change in each subsequent round, the combat is to be performed in such a skill release order.

For another example, if an agility value of a PC is less than that of an NPC, prompt information is displayed at the beginning of one round, and the player selects a skill released by the PC. In a combat animation, the PC first releases a skill, and the NPC then releases a skill. If the agility values of the two characters do not change in each subsequent round, the combat is to be performed in such a skill release order.

In some aspects, a sequence in which the PC and the NPC release skills in each round may further be determined based on any one of the following parameters: a level, a health point, attack power, and defense power.

Still referring to FIG. 3A, in operation 302, prompt information related to a to-be-released skill of the NPC is displayed in response to currently being in a process of waiting to receive a skill triggering operation for the PC. For example, notification information that includes NPC skill information associated with an NPC skill of the NPC that is to be performed in a next turn of the NPC in the turn-based game is displayed. The notification information is displayed during a turn of the virtual character that precedes the next turn of the NPC and in which a skill triggering operation for the virtual character is to be performed by a user.

For example, when the player selects a skill to be released for the PC, the to-be-released skill of the NPC has been determined in advance, and prompt information of the to-be-released skill of the NPC may be displayed, so that the player formulates an interaction strategy of a virtual object controlled by the player.

In some aspects, prompting manners of the prompt information include a direct prompt, an indirect prompt, a positive prompt, a negative prompt, and a text prompt. Each prompting manner is explained below.

In some aspects, a type of the prompt information is a direct prompt. The direct prompt means directly displaying an identifier characterizing the to-be-released skill of the NPC.

Operation 302 is implemented in the following manner: displaying first prompt information for indicating the to-be-released skill of the NPC, the first prompt information including at least an identifier of the to-be-released skill. The identifier may be an icon or a name.

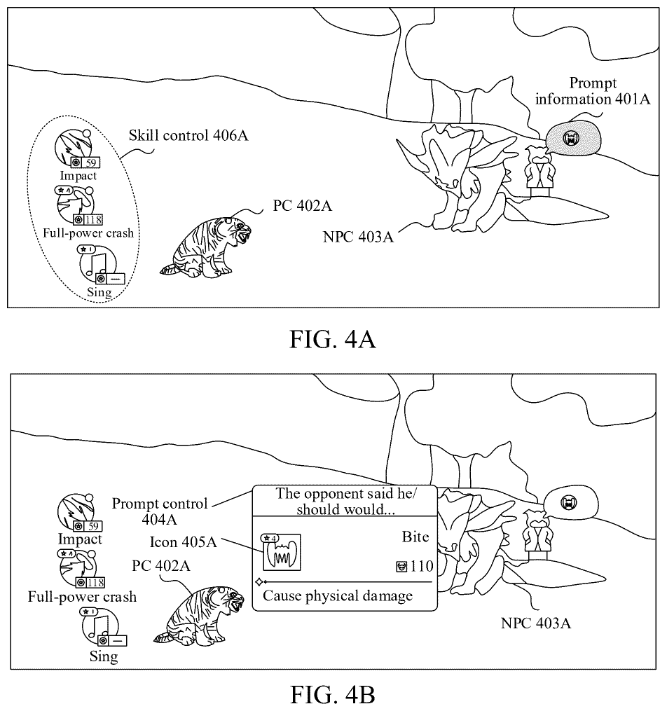

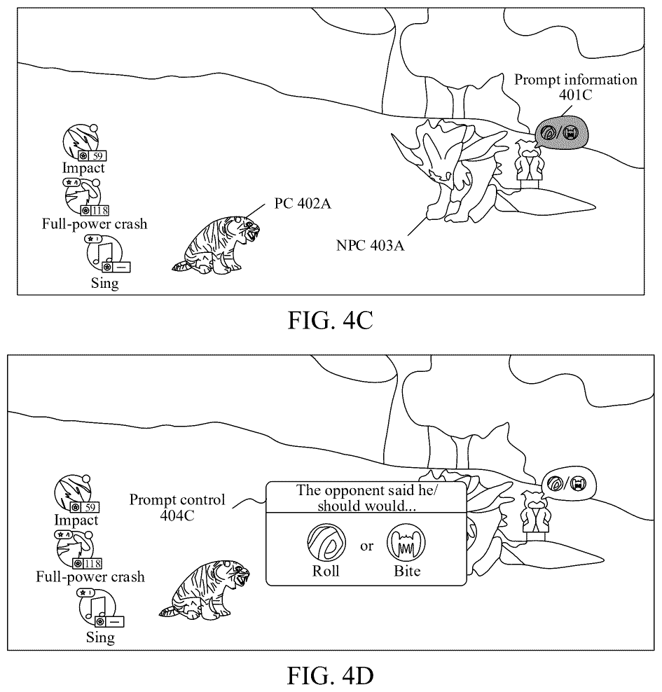

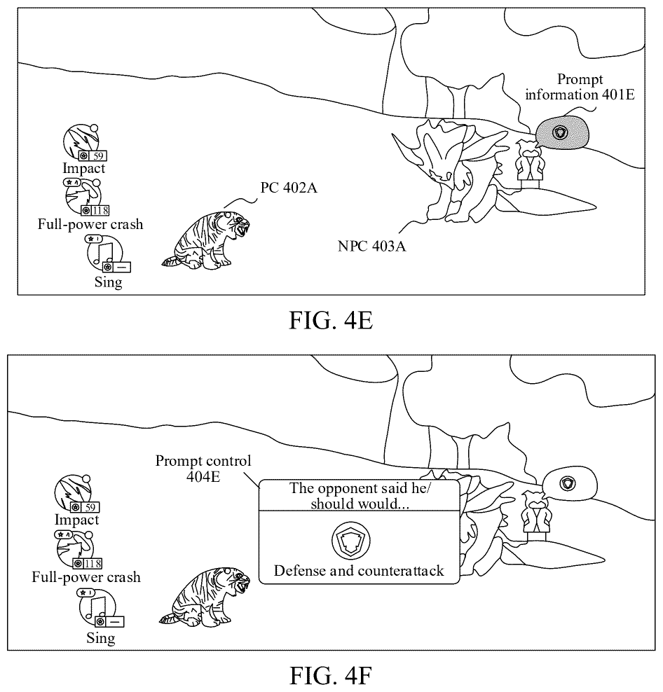

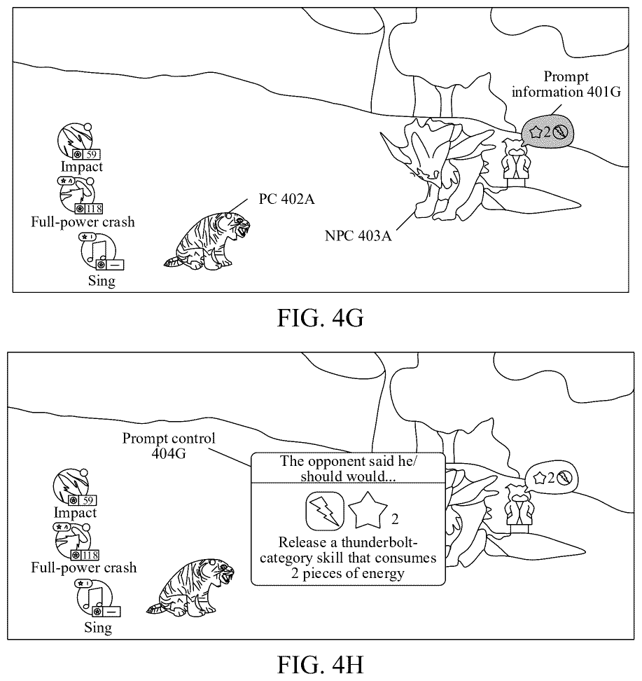

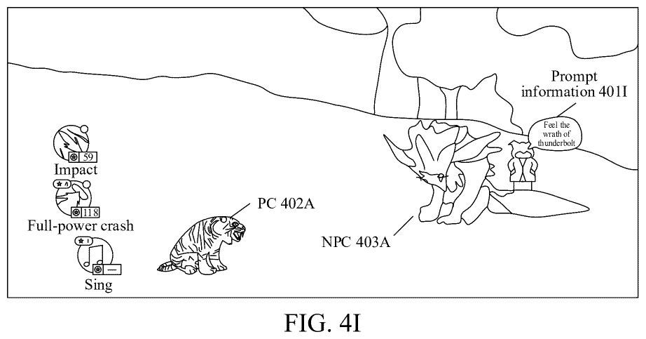

FIG. 4A is a first schematic diagram of a human-computer interaction interface according to an aspect of this disclosure. A round-based battle is performed between a PC 402A and an NPC 403A. Before the PC 402A releases a skill, prompt information 401A (first prompt information) is displayed near the NPC 403A. The prompt information 401A is prompt information in a direct prompting manner, and an icon in the prompt information 401A is an icon of a to-be-released skill of the NPC in a next round.

For example, after the first prompt information configured for indicating the to-be-released skill of the NPC is displayed, detailed information of the to-be-released skill is displayed in response to a triggering operation for the first prompt information. The detailed information includes at least one of the following: a skill type of the to-be-released skill, an attribute parameter change caused by the to-be-released skill, a skill name, and virtual energy consumed by the to-be-released skill.

For example, the detailed information of the to-be-released skill may be displayed in a pre-configured area or a prompt control. The pre-configured area may be configured based on a user requirement in an actual application scenario. The pre-configured area is for example an overhead area of an NPC, and a central area of a human-computer interaction interface.

For example, the triggering operation may be any one of the following: touch and hold, clicking/tapping, and sliding. The attribute parameter change caused by the to-be-released skill may be an increase of the attribute parameter of the NPC, or a decrease of the attribute parameter of the PC.

FIG. 4B is a second schematic diagram of a human-computer interaction interface according to an aspect of this disclosure. When a player triggers prompt information 401A, a prompt control 404A is displayed, and detailed information of the prompt information 401A is displayed in the prompt control 404A, including: a skill name (bite), energy (4 energy values) consumed by a skill, a skill type (physical damage), and damage caused by a to-be-released skill to a PC being 110, and a skill icon (an icon 405A). The player may determine, based on detailed prompt information, a skill to be released in a current round, and trigger one of skill controls 406A.

For example, skill types in a virtual scene include attack, defense, health point regeneration, or energy regeneration.

In this aspect of this disclosure, the detailed information of the to-be-released skill of the NPC is directly prompted to the user, so that the user determines the to-be-released skill of the NPC, which saves time for the user to determine the to-be-released skill of the PC, reduces the difficulty of the game, enhances experience of the player in the game, and improves human-computer interaction efficiency.

In some aspects, the type of the prompt information is a positive prompt. The positive prompt means presenting a plurality of skills to the user. The plurality of skills certainly include the to-be-released skill of the NPC.

Operation 302 is implemented in the following manner: displaying second prompt information including a plurality of skills, the plurality of skills including the to-be-released skill of and another skill possessed by the NPC, and the second prompt information including at least identifiers of the plurality of to-be-released skills.

FIG. 4C is a third schematic diagram of a human-computer interaction interface according to an aspect of this disclosure. A round-based battle is performed between a PC 402A and an NPC 403A. Before the PC 402A releases a skill, prompt information 401C (second prompt information) is displayed near the NPC 403A. The prompt information 401C is prompt information in a range prompt (positive prompt) manner. Two icons in the prompt information 401A include an icon of a to-be-released skill of the NPC in a next round, and an icon of a skill possessed by the NPC.

For example, after the second prompt information including a plurality of skills is displayed, a prompt control is displayed in response to a triggering operation for the second prompt information, and detailed information of the to-be-released skill is displayed in the prompt control. The detailed information includes at least one of the following: skill types and skill names of the plurality of to-be-released skills.

FIG. 4D is a fourth schematic diagram of a human-computer interaction interface according to an aspect of this disclosure. When a player clicks/taps or touches and holds prompt information 401C, a prompt control 404C is displayed, and detailed information of the prompt information 401C is displayed in the prompt control 404C, including: a skill name (bite or roll), and a zoom-in icon of a skill. The player may determine, based on detailed prompt information, a skill to be released in a current round, and trigger one of skill controls 406A.

In this aspect of this disclosure, a plurality of skills including a to-be-released skill of an NPC are displayed to a user, so that the user decides the to-be-released skill of a PC. The player may guess the to-be-released skill of the NPC based on the prompted plurality of skills, which increases fun of the player in the game, and can improve a retention rate of the player for the game, improve experience of the player in the game, and improve human-computer interaction efficiency.

In some aspects, the type of the prompt information is a negative prompt. The negative prompt means displaying a skill that the NPC is definitely not to release.

Operation 302 is implemented in the following manner: displaying third prompt information including at least one skill, the third prompt information being configured for indicating a skill that the NPC is not to release, and the third prompt information including a first icon of the at least one skill.

FIG. 4E is a fifth schematic diagram of a human-computer interaction interface according to an aspect of this disclosure. A round-based battle is performed between a PC 402A and an NPC 403A. Before the PC 402A releases a skill, prompt information 401E (third prompt information) is displayed near the NPC 403A. The prompt information 401E is prompt information in an error prompting manner (negative prompt), and a skill icon in the prompt information 401E is an icon of a skill that the NPC is not to release in a current round.

For example, after the third prompt information including at least one skill is displayed, a prompt control is displayed in response to a triggering operation for the third prompt information, and a second icon and a skill name of the at least one skill are displayed in the prompt control. A size of the second icon is greater than that of the first icon.

For example, a difference exists between detailed information of the negative prompt and the direct prompt, so that a user identifies a prompt type. FIG. 4F is a sixth schematic diagram of a human-computer interaction interface according to an aspect of this disclosure. When a player triggers prompt information 401E, a prompt control 404E is displayed, and detailed information of the prompt information 401E is displayed in the prompt control 404E, including a large skill icon and a skill name (defense and counterattack). The detailed information of the prompt information 401E is different from detailed information of a direct prompt, and the player may determine a prompting manner based on a format of the prompt information. The skill name defense and counterattack characterizes that the skill is a skill for defense.

In some aspects, a type of the prompt information is an indirect prompt. The indirect prompt means implication. Information such as a related parameter of a to-be-released skill is provided to the user, rather than information that can uniquely characterize the to-be-released skill such as a name or an icon of the to-be-released skill being displayed.

Operation 302 is implemented in the following manner: displaying fourth prompt information for characterizing a skill type of the to-be-released skill of the NPC, the fourth prompt information including at least an identifier of the skill type of the to-be-released skill.

FIG. 4G is a seventh schematic diagram of a human-computer interaction interface according to an aspect of this disclosure. A round-based battle is performed between a PC 402A and an NPC 403A. Before the PC 402A releases a skill, prompt information 401G (fourth prompt information) is displayed near the NPC 403A. The prompt information 401G is prompt information as an implied prompt. The prompt information 401G includes a skill type icon.

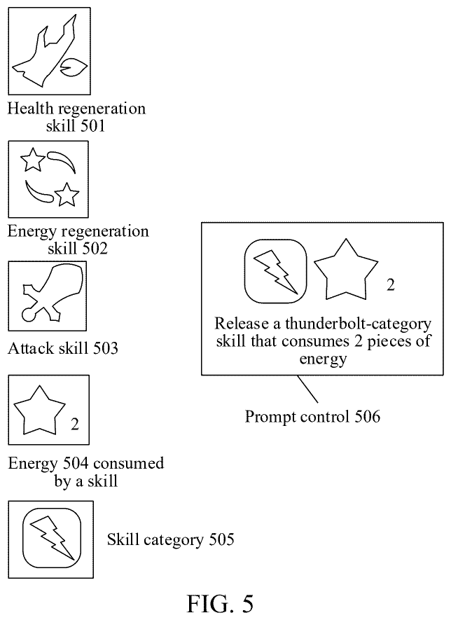

For ease of understanding, icons and names of skill types are explained and described below. FIG. 5 is a schematic diagram of icons of skills according to an aspect of this disclosure. Skill type icons include a health regeneration skill 501, an energy regeneration skill 502, an attack skill 503, energy 504 consumed by a skill (two energy values shown in FIG. 5 as an example), and a skill category 505 (a thunderbolt-category skill shown in FIG. 5 as an example). The energy 504 consumed by the skill and the skill category 505 are combined into prompt information in a prompt control 506. The prompt information refers to a meaning of releasing a thunderbolt-category skill that consumes 2 pieces of energy. In other words, a to-be-released skill of the NPC 403A is a thunderbolt-category skill that consumes two pieces of virtual energy, and a player may analyze the to-be-released skill of the NPC based on an implied prompt.

FIG. 4H is an eighth schematic diagram of a human-computer interaction interface according to an aspect of this disclosure. When a player triggers prompt information 401G, a prompt control 404G is displayed, and detailed information of the prompt information 401G is displayed in the prompt control 404G, including icons of skill types. The prompt information refers to a meaning of releasing a thunderbolt-category skill that consumes 2 pieces of energy. The to-be-released skill of the NPC is a thunderbolt-category skill that consumes two pieces of virtual energy. The player may analyze the to-be-released skill of the NPC based on an implied prompt.

In this aspect of this disclosure, a type icon including a to-be-released skill of an NPC is displayed to a user, so that the user decides the to-be-released skill of a PC. The player may guess the to-be-released skill of the NPC, which increases fun of the player in the game, and can improve a retention rate of the player for the game, improve experience of the player in the game, and improve human-computer interaction efficiency.

In some aspects, a type of the prompt information is a text prompt. Operation 302 is implemented in the following manner: displaying text prompt information for characterizing the to-be-released skill of the NPC.

FIG. 4I is a ninth schematic diagram of a human-computer interaction interface according to an aspect of this disclosure. A round-based battle is performed between a PC 402A and an NPC 403A. Before the PC 402A releases a skill, prompt information 401I is displayed near the NPC 403A. The prompt information 401I is a text prompt with content of “Feel the wrath of thunderbolt”. The player analyzes and determines a to-be-released skill of the NPC based on the text prompt information, and then determines, based on an analysis result, a skill released by the PC.

In this aspect of this disclosure, a text prompt including a to-be-released skill of an NPC is displayed to a user, so that the user decides the to-be-released skill of a PC. The player may autonomously guess the to-be-released skill of the NPC, which increases fun of the player in the game, and can improve a retention rate of the player for the game, improve experience of the player in the game, and improve human-computer interaction efficiency. In addition, the text prompting manner enables the NPC to be more anthropomorphic and real, thereby enhancing a sense of reality of a virtual scene.

In some aspects, FIG. 3B is a second schematic flowchart of an interaction processing method for a virtual scene according to an aspect of this disclosure. Before text prompt information for characterizing a to-be-released skill of an NPC is displayed, operation 3021 to operation 3023 in FIG. 3B are performed.

In operation 3021, configuration information of the to-be-released skill of the NPC is obtained. For example, configuration information of the NPC skill is obtained. The configuration information includes at least one of: a skill name, a skill type, a virtual resource consumed by the NPC skill, and an attribute parameter change caused by the NPC skill.

For example, types of the configuration information include at least one of the following: a skill name, a skill type, virtual energy consumed by a skill, and an attribute parameter change caused by the skill.

Skill types include attack, defense, health point regeneration, or energy regeneration. An attribute parameter change caused by a skill may be for the NPC or a PC. The attribute parameter change for the PC includes a decrease in a health point, an energy decrease, a speed decrease, or the like. The attribute parameter change for the NPC includes an increase in a health point, an energy increase, a speed increase, or the like.

In operation 3022, a skill text relationship table is queried for text information corresponding to each piece of the configuration information based on the configuration information of the to-be-released skill. For example, the text information is determined by querying a skill text relationship table based on the configuration information. The skill text relationship table includes correspondences between different configuration information and pre-configured text information.

For example, the skill text relationship table is configured to store a correspondence between different configuration information (parameters) and pre-configured text information. For content of the skill text relationship table, reference may be made to the following table (1):

TABLE 1

| Parameter | Text |
|---|---|
| First parameter interval skill | “Be careful” |
| Second parameter interval skill | “I'm going to kill you” |
| First energy interval skill | “Going to save energy” |
| Second energy interval skill | “I'm going to use my Ultimate” |
| Water-category skill | “Do you have an umbrella” |
| Thunderbolt-category skill | “Feel the wrath of thunderbolt” |
| Health point regeneration skill | “It's time to regenerate” |
| Energy regeneration skill | “It's time to take a break” |
| Attack skill | “I'm going to crush you” |
| Defense skill | “Invalid attack” |

For example, it is assumed that numerical values of health point reduction caused by an attack skill are divided into a first parameter interval and a second parameter interval, the numerical values of health point reduction in the first parameter interval being less than those in the second parameter interval. Energy consumed by a skill is divided into a first energy interval and a second energy interval, a numerical value of energy consumption of the first energy interval being within the second energy interval.

For example, the obtained configuration information of the to-be-released skill of the NPC includes a water-category skill, and the energy consumed being 4, which fall within the second energy interval, and the numerical value of health point reduction caused being 100, which falls within the second parameter interval. Table (1) above is queried based on the configuration information of the to-be-released skill, to obtain 4 pieces of text information.

In operation 3023, the found text information is combined into the text prompt information of the to-be-released skill.

For example, a plurality of pieces of different text information may be found based on the configuration information corresponding to the skill, and at least one piece of the found text information is selected for combination, to obtain the displayed text prompt information. In some aspects, a planner assigns a different priority to each type of configuration information in advance, and selects text information of configuration information with a highest priority as the text prompt information.

Still referring to FIG. 3A, in operation 303, in response to the skill triggering operation for the PC, the PC is controlled to release a skill triggered by the skill triggering operation. For example, the virtual character is controlled to perform a triggered skill based on the skill triggering operation for the virtual character.

For example, the prompt information is used as reference information of the skill triggering operation. For any of the foregoing prompt information, the user may guess the to-be-released skill of the NPC based on the prompt information, thereby improving interaction efficiency between the user and the NPC, and enhancing gaming fun of the user.

In some aspects, FIG. 3D is a fourth schematic flowchart of an interaction processing method for a virtual scene according to an aspect of this disclosure. After operation 306 in FIG. 3C, operation 307 to operation 308 in FIG. 3D are performed, and operation 308 is performed before operation 302.

In operation 307, a mapping relationship table is queried for a current prompting manner corresponding to the NPC based on a personality type corresponding to the NPC. For example, a mapping relationship table for a current notification type corresponding to the NPC is queried based on a personality type corresponding to the NPC. The mapping relationship table includes mapping relationships between different personality types and different notification types.

For example, the mapping relationship table stores mapping relationships between different personality types and different prompting manners. In the mapping relationship table, a relationship between a personality type and a prompting manner may be one-to-one or one-to-many. For the mapping relationship table, reference may be made to the following table (2):

TABLE 2

| Personality type | Prompting manner |
|---|---|
| Taciturn | No prompt, indirect prompt, and text prompt |
| Timid | No prompt, indirect prompt, and text prompt |
| Frank | Direct prompt |
| Irritable | Direct prompt |
| Cautious | Positive prompt and indirect prompt |
| Crafty | Negative prompt |
| Friendly | Direct prompt and text prompt |
| Naughty | Negative prompt and positive prompt |

Each personality corresponds to at least one prompting manner. When the NPC has a plurality of corresponding prompting manners, in each round, one of the plurality of prompting manners may be selected in various manners as a prompting manner in a current round, or a plurality of prompting manners of the NPC are numbered, and different prompting manners are cyclically used in sequence in each round. For example, a friendly NPC uses the direct prompt in an odd-numbered round, uses the text prompt in an even-numbered round, and uses different prompting manners alternately and cyclically.

In operation 308, the prompt information related to the to-be-released skill of the NPC is generated based on the current prompting manner and the to-be-released skill. For example, the notification information is generated based on the current notification type and the NPC skill.

In some aspects, operation 308 may be implemented in the following manners:
generating first prompt information for indicating the to-be-released skill of the NPC when the current prompting manner is a direct prompt;
generating second prompt information including a plurality of skills when the current prompting manner is a positive prompt, the plurality of skills including the to-be-released skill of and another skill possessed by the NPC;
generating third prompt information including at least one skill when the current prompting manner is a negative prompt, the third prompt information being configured for indicating a skill that the NPC is not to release;
generating fourth prompt information for characterizing a skill type of the to-be-released skill of the NPC when the current prompting manner is an indirect prompt; and
generating text prompt information for characterizing the to-be-released skill of the NPC when the current prompting manner is a text prompt.

For example, for the different types of prompt information in operation 308, reference may be to operation 302 above, and details are not described herein again.

In this aspect of this disclosure, different personalities and different prompting manners are preset for the NPC, thereby improving a sense of reality of the NPC, and enhancing fun of the user in a game.

In some aspects, before operation 302, in response to the PC meeting a first display condition, operation 302 is performed. The first display condition includes at least one of the following:

Condition 1: A difference between the attribute parameter of the NPC and the attribute parameter of the PC is greater than a pre-configured difference. A type of the attribute parameter includes at least one of the following: a remaining health point, remaining virtual energy, attack power, and a character level, the virtual energy being energy consumed for releasing a skill. The pre-configured parameter may be pre-configured based on an actual application scenario, and pre-configured differences corresponding to different types of attribute parameters may be different.

Condition 2: A victory probability of the PC against the NPC is less than a first win rate threshold.

For example, before a PC enters a round-based interaction, data of interaction that has been performed by the PC for a current NPC is obtained, and a ratio of a quantity of wins to a total quantity of the round-based interactions is calculated as a victory probability. The first win rate threshold may be pre-configured based on an application scenario.

Condition 3: A historical victory probability of each of a plurality of PCs against the NPC is less than a second win rate threshold.

For example, assuming that a PC has never interacted with a current NPC, a historical victory probability of each of a plurality of other PCs for the NPC may be obtained as reference. If the historical victory probability is less than the second win rate threshold, a prompt is displayed. The historical victory probability of the plurality of PCs may be obtained in the following manner: obtaining a total quantity of historical combats and a quantity of historical wins of the plurality of PCs for the current NPC, and using a ratio of the quantity of historical wins to the total quantity of historical combats as the historical victory probability. For example, (the quantity of historical wins/the total quantity of historical combats)*100%=the historical victory probability.

In some aspects, before operation 302, in response to the virtual scene meeting the second display condition, operation 302 is performed. The second display condition includes at least one of the following:

Condition 4: A terrain in which the PC is located in the virtual scene is at a disadvantage compared to the NPC. For example, a planner may pre-configure a relationship between a different terrain and a character for a PC and an NPC. If a terrain in which the PC is located in the virtual scene is at a disadvantage compared to the NPC, prompt information is displayed.

Condition 5: A distance between the PC and the NPC in the virtual scene is greater than a distance threshold. For example, in some games, a distance between two parties of a battle affects an effect of the battle, for example, a simulated shooting game. A distance threshold may be pre-configured by a game planner. When a distance between a PC and an NPC in a virtual scene is greater than the distance threshold, prompt information is displayed.

Condition 6: The virtual scene has a buff attribute for the attribute parameter of the NPC. For example, a type of the buff attribute includes a health point buff, a defense power buff, an energy buff, a speed buff, or the like.

In this aspect of this disclosure, the prompt information is displayed when a specific condition is met, which avoids a waste of computing resources of an image processor caused by frequently displaying the prompt information.

In the aspects of this disclosure, during the round-based interaction, before the player releases a skill, prompt information related to a to-be-released skill of the NPC is displayed, and the prompt information is used as reference information for the PC to release the skill, so that the player decides the skill to be released by the PC, thereby improving interaction efficiency in the virtual scene, and saving computing resources required by the virtual scene. In this way, operation difficulty of the user is reduced, and then user experience is improved.

For example, An application of the interaction processing method for a virtual scene in the aspects of this disclosure in an actual application scenario is described below.

In a related round-based game, a behavior of an NPC controlled by a computer is not prompted in advance, and when a player is fighting against the computer, the player cannot guess a next skill to be used by the NPC. When a player formulates an interaction strategy, the player can only specify a strategy conventionally, and cannot experience fun of interaction. When the player plays a game for a long time, such experience makes the player feel no interest in interacting with an NPC, and reduces an interactive behavior of the players fighting in a battle environment.

The related art has the following problems.

1. A player spends most of the time in combat against the NPC in a game, and lack of combat-related prompt information may cause the player to quickly lose interest in the game, resulting in user loss of the game.

2. The player cannot predict a behavior of an NPC, and cannot defeat the NPC. Therefore, in a game program, to prevent a case that a combat with higher challenge cannot be constructed as a result of an excessively low victory probability of the player, the combats with the NPC are highly homogenized and lack challenge.

3. A player has a single sense of achievement in a combat against a computer, can only feel a sense of achievement brought by improvement in level of a numerical value, but cannot feel a sense of achievement brought by combat decisions.

According to the interaction processing method for a virtual scene provided in the aspects of this disclosure, in a round-based interaction process, prompt information related to a skill of an NPC is displayed, thereby increasing interaction between a player and the NPC, so that the NPC is more anthropomorphic and vivid. The player may use the prompt information as reference, and determine, based on the reference, an interaction strategy to counterattack the NPC. The fun of the player in fighting against the NPC is increased to improve retention of the player. Prompt information is provided to the player, so that a combat design may be more complex. The player can win these complex combats more easily by reading the prompt information, thereby enhancing gaming experience of the player.

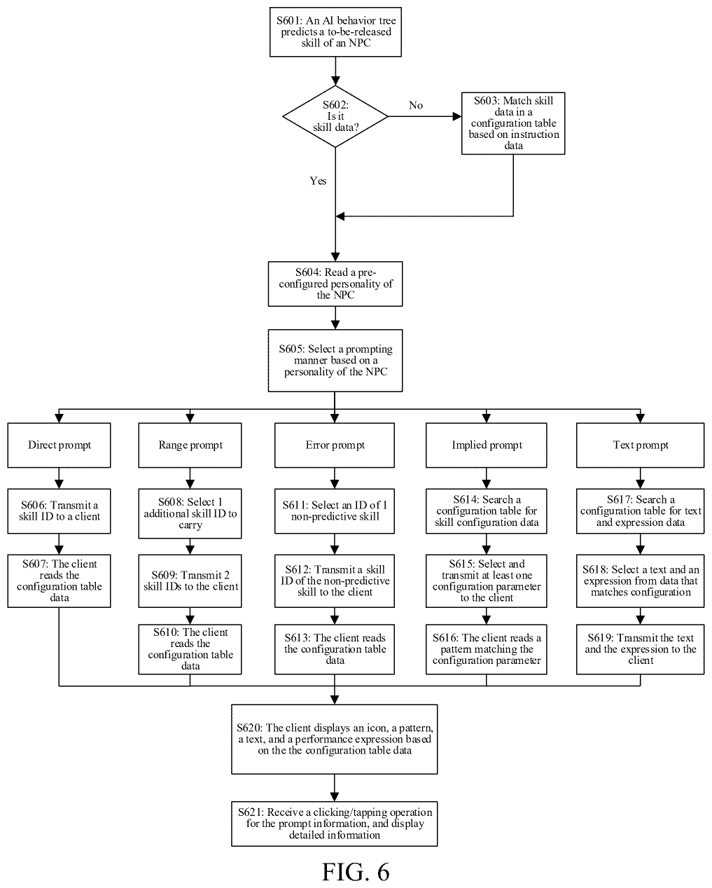

The interaction processing method for a virtual scene provided in the aspects of this disclosure is described below with reference to the accompanying drawings. FIG. 6 is a fifth schematic flowchart of an interaction processing method for a virtual scene according to an aspect of this disclosure. An example in which a server and a terminal device perform the method and a virtual scene is a virtual scene of an on-line game is used for description.

Operation S601: An AI behavior tree predicts a to-be-released skill of an NPC.

Operation S601 is performed by a server.

For example, the AI behavior tree is a mathematical model of plan execution used in computer science, robotics, control systems, and video games. The behavior tree is configured to configure a behavior of an NPC in each round, and predetermine a skill or a behavior to be used by the NPC in the round.

Operation S602: Determine whether data obtained through prediction is skill data. When a result of operation S602 is No, operation S603 of matching skill data in a configuration table based on instruction data is performed. When a result of operation S602 is Yes, operation S604 of reading a pre-configured personality of the NPC is performed. After operation S603, operation S604 is also performed.

It is assumed that in each round, a PC first releases a skill, and an NPC then releases a skill. Before the PC releases the skill, the server may calculate, in advance based on the behavior tree, a skill to be used by the NPC in the current round. If no skill is used, but an instruction or another behavior is used, the server invokes a configuration table. The configuration table stores a correspondence between a behavior and a skill ID, converts the behavior of the NPC in the current round into a skill ID, and notifies a client in the terminal device of the skill ID. The client invokes prompt information corresponding to the skill ID based on the skill ID, and displays the prompt information near the NPC (for example, a left or right position of a head), so as to display the prompt information to a player in a form of a bubble box.

Operation S605: Select a prompting manner based on a personality of the NPC.

For example, prompting manners include a direct prompt, an implied prompt (the indirect prompt above), a range prompt (the positive prompt above), an error prompt (the negative prompt above), and a text prompt. A type of the prompt ultimately used by the NPC is determined based on a personality set by the planner for the NPC. Different types of prompts are used based on different personalities pre-configured for virtual monsters. For a correspondence between the personality and the prompt type, refer to the following Table (3).

TABLE 3

| Personality | Prompt type used |
|---|---|
| Taciturn | No prompt, hint, and text prompt |
| Timid | No prompt, hint, and text prompt |
| Frank | Direct prompt |
| Irritable | Direct prompt |
| Cautious | Range prompt and hint |
| Crafty | Error prompt |
| Friendly | Direct prompt and text prompt |
| Naughty | Error prompt and range prompt |

In some aspects, each NPC may have a plurality of personalities, and the server selects in various manners, as a prompting manner used in the current round, one of all prompt types that meet the personality composition.

When the prompting manner is the direct prompt, operation S606 to operation S607 are performed.

In operation S606, a skill ID is transmitted to a client.

For example, the server transmits the determined skill ID of the to-be-released skill of the NPC to the client.

In operation S607, the client reads configuration table data.

For example, the client may query a database for the configuration table data corresponding to the to-be-released skill based on the skill ID of the to-be-released skill. The configuration table data includes an icon, a skill pattern, text corresponding to a skill, and a performance expression.

After operation S607, operation S620 of displaying the icon, the pattern, the text, and the performance expression by the client based on the configuration table data is performed.

For example, the performance expression is applied to a two-dimensional or three-dimensional model of an NPC, so that the model of the NPC displays an expression and an action related to the to-be-released skill in a virtual scene. When the skill is a skill acting on the PC, the performance expression is further configured for enabling the PC to display an expression and an action affected by the skill. Performance expressions of different skills may be the same or different. For example, for skills of the same function type but different strengths, the performance expressions may be the same. For skills of different function types, the performance expressions may be different.

Operation S621: Receive a clicking/tapping operation for the prompt information, and display detailed information.

For example, if it is difficult for a player to determine a to-be-released skill based on a displayed icon, pattern, text, and performance expression, the player may click/tap prompt information on a human-computer interaction interface of a terminal device to view the detailed information.

FIG. 4A is a first schematic diagram of a human-computer interaction interface according to an aspect of this disclosure. A round-based battle is performed between a PC 402A and an NPC 403A. Before the PC 402A releases a skill, prompt information 401A is displayed near the NPC 403A. The prompt information 401A is prompt information in a direct prompting manner, and an icon in the prompt information 401A is an icon of a to-be-released skill of the NPC in a next round.

FIG. 4B is a second schematic diagram of a human-computer interaction interface according to an aspect of this disclosure. When a player clicks/taps or touches and holds prompt information 401A, a prompt control 404A is displayed, and detailed information of the prompt information 401A is displayed in the prompt control 404A, including: a skill name (bite), energy (4 energy values) consumed by a skill, a skill type (physical damage), and a skill icon (an icon 405A). The player may determine, based on detailed prompt information, a skill to be released in a current round, and trigger one of skill controls 406A.

When the prompting manner is a range prompt (the positive prompt above), operation S608 to operation S610 are performed.

In operation S608, 1 additional skill ID to carry is selected.

For example, after a target skill ID of a to-be-released skill of an NPC has been determined, a skill ID other than the target skill ID is selected in various manners.

In operation S609, 2 skill IDs are transmitted to a client.

For example, the two skill IDs that are transmitted are the determined target skill ID of the to-be-released skill of the NPC and the skill ID selected in various manners.

In operation S610, the client reads configuration table data.

For example, the client queries a database for the foregoing 2 skill IDs based on the skill ID, to obtain the configuration table data respectively corresponding to the 2 skill IDs. Content of the configuration table data has been described in operation S607, and details are not described herein again.

After operation S610, operation S620 of displaying the icon, the pattern, the text, and the performance expression by the client based on the configuration table data is performed.

For example, after operation S610, the client displays icons, patterns, texts, and performance expressions corresponding to the 2 skill IDs. Content displayed by the client certainly includes content corresponding to the to-be-released skill. The user may analyze, based on the icons, patterns, texts, and performance expressions respectively corresponding to the 2 skill IDs, that which one of 2 skills is the to-be-released skill of the NPC and is an actual to-be-released skill.

Operation S621: Receive a clicking/tapping operation for the prompt information, and display detailed information.

For example, if it is difficult for a player to determine the actual to-be-released skill based on a displayed icon, pattern, text, and performance expression, the player may click/tap prompt information on a human-computer interaction interface of a terminal device to view the detailed information.

FIG. 4C is a third schematic diagram of a human-computer interaction interface according to an aspect of this disclosure. A round-based battle is performed between a PC 402A and an NPC 403A. Before the PC 402A releases a skill, prompt information 401C is displayed near the NPC 403A. The prompt information 401C is prompt information in a range prompting manner. Two icons in the prompt information 401A include an icon of a to-be-released skill of the NPC in a next round, and an icon of a skill possessed by the NPC.

FIG. 4D is a fourth schematic diagram of a human-computer interaction interface according to an aspect of this disclosure. When a player clicks/taps or touches and holds prompt information 401C, a prompt control 404C is displayed, and detailed information of the prompt information 401C is displayed in the prompt control 404C, including: a skill name (bite or roll), and a zoom-in icon of a skill. The player may determine, based on detailed prompt information, a skill to be released in a current round, and trigger one of skill controls 406A.

When the prompting manner is an error prompt (the negative prompt above), operation S611 to operation S613 are performed.

In operation S611, an ID of 1 non-predictive skill is selected.

For example, a predictive skill refers to a to-be-released skill, and the non-predictive skill refers to any skill other than the to-be-released skill. A skill ID is selected from any skill other than the to-be-released skill.

In operation S612, a skill ID of the non-predictive skill is transmitted to a client.

A principle of operation S612 is the same as a principle of operation S606, and details are not described herein again.

In operation S613, the client reads configuration table data.

A principle of operation S613 is the same as a principle of operation S607, and details are not described herein again.

After operation S613, operation S620 of displaying the icon, the pattern, the text, and the performance expression by the client based on the configuration table data is performed.

For example, the icon, the pattern, the text, and the performance expression displayed by the client are skills that the NPC is not to release in a next round. The user may exclude, from all skills of the NPC, the skill that the NPC is not to release, and determine the to-be-released skill of the NPC from remaining skills in all the skills based on the foregoing prompt content, thereby increasing interest of the user in the game and enhancing gaming experience of the user.

Operation S621: Receive a clicking/tapping operation for the prompt information, and display detailed information.

The principle and function of operation 621 have been described above, and details are not described herein again.

FIG. 4E is a fifth schematic diagram of a human-computer interaction interface according to an aspect of this disclosure. A round-based battle is performed between a PC 402A and an NPC 403A. Before the PC 402A releases a skill, prompt information 401E is displayed near the NPC 403A. The prompt information 401E is prompt information in an error prompting manner, and a skill icon in the prompt information 401E is an icon of a skill that the NPC is not to release in a current round.

FIG. 4F is a sixth schematic diagram of a human-computer interaction interface according to an aspect of this disclosure. When a player clicks/taps or touches and holds prompt information 401E, a prompt control 404E is displayed, and detailed information of the prompt information 401E is displayed in the prompt control 404E, including a large skill icon and a skill name (defense and counterattack). The detailed information of the prompt information 401E is different from detailed information of a direct prompt, and the player may determine a prompting manner based on a format of the prompt information.

When the prompting manner is an implied prompt (the indirect prompt above), operation S614 to operation S616 are performed.

In operation S614, a configuration table is searched for skill configuration data.

For example, a server queries the configuration table for the skill configuration data based on a determined skill ID of a to-be-released skill of an NPC. The skill configuration data includes a plurality of configuration parameters of a skill.

In operation S615, at least one configuration parameter is selected and transmitted to a client.

For example, one of the plurality of configuration parameters of the to-be-released skill is selected in various manners and transmitted to the client.

In operation S616, the client reads a pattern matching the configuration parameter.

For example, the client reads a pattern of a skill based on the configuration parameter, and the pattern matching the configuration parameter may be a skill type icon.

After operation S616, operation S620 of displaying the icon, the pattern, the text, and the performance expression by the client based on the configuration table data is performed.

After operation 616, when operation 620 is performed, the client displays only the skill type icon matching the configuration parameter.

FIG. 4G is a seventh schematic diagram of a human-computer interaction interface according to an aspect of this disclosure. A round-based battle is performed between a PC 402A and an NPC 403A. Before the PC 402A releases a skill, prompt information 401G is displayed near the NPC 403A. The prompt information 401G is prompt information as an implied prompt. The prompt information 401G includes a skill type icon.

FIG. 5 is a schematic diagram of icons of skills according to an aspect of this disclosure. Skill type icons include a health regeneration skill 501, an energy regeneration skill 502, an attack skill 503, energy 504 consumed by a skill (two energy values shown in FIG. 5 as an example), and a skill category 505 (a thunderbolt-category skill shown in FIG. 5 as an example). The energy 504 consumed by the skill and the skill category 505 are combined into prompt information in a prompt control 506. The prompt information refers to a meaning of releasing a thunderbolt-category skill that consumes 2 pieces of energy. In other words, a to-be-released skill of the NPC 403A is a thunderbolt-category skill that consumes two pieces of virtual energy, and a player may analyze the to-be-released skill of the NPC based on an implied prompt.

For example, a skill category in a game is formulated by a game planner.

Operation S621: Receive a clicking/tapping operation for the prompt information, and display detailed information.

For example, the principle and function of operation S621 have been described above, and details are not described herein again.

FIG. 4H is an eighth schematic diagram of a human-computer interaction interface according to an aspect of this disclosure. When a player clicks/taps or touches and holds prompt information 401G, a prompt control 404G is displayed, and detailed information of the prompt information 401G is displayed in the prompt control 404G, including icons of skill types. The prompt information refers to a meaning of releasing a thunderbolt-category skill that consumes 2 pieces of energy. The player may analyze the to-be-released skill of the NPC based on an implied prompt.

When the prompting manner is a text prompt, operation S617 to operation S619 are performed.

In operation S617, a configuration table is searched for text and expression data.

For example, the configuration table includes a plurality of types of attributes, for example, a parameter change caused by a skill, energy consumed by a skill, a skill type, and a skill category. Skill types include a health point regeneration type, an energy regeneration type, an attack skill, and a defense skill. The skill category is pre-configured by a planner, for example, a thunderbolt category, a water category, or the like.

For a configuration table between a parameter and a text, reference may be made to the following Table (4).

TABLE 4

| Parameter | Text |
|---|---|
| First parameter interval | Weak threat type-“Be careful” |
| skill | |
| Second parameter interval | Strong threat type-“I'm going to kill you” |
| skill | |
| First energy interval skill | Prompt type-“Going to save energy” |
| Second energy interval skill | Prompt type-“I'm going to use my |
| | Ultimate” |
| Skill of a specific category | Water category-“Do you have an |
| | umbrella” |
| | Thunderbolt category-“Feel the wrath of |
| | thunderbolt” |
| Health point regeneration | Description type-“It's time to regenerate” |
| skill | |
| Energy regeneration skill | Description type-“It's time to take a break” |
| Attack skill | Threat type-“I'm going to crush you” |

Energy consumed by a skill in the second energy interval is higher than that consumed by a skill in the first energy interval, and a parameter change caused by a skill in the second parameter interval is greater than that caused by a skill in the first parameter interval.

In operation S618, a text and an expression are selected from data that matches configuration.

Assuming that the to-be-released skill of the NPC is a fire-category attack skill that causes damage of 60 (in other words, a health point reduction of 60 can be caused) and consumes energy of 6, the damage of 60 falls within the second parameter interval, and the energy of 6 falls within the second energy interval. The following texts are extracted from the configuration table based on the parameter corresponding to the to-be-released skill: the text “I'm going to kill you” of the skill in the second parameter interval, the text “I'm going to use my Ultimate” of the skill in the second energy interval, the text “I'm going to crush you” of the attack skill. The extracted texts are used as candidate texts, one of the candidate texts is selected in various manners as a finally displayed prompt text, and the selected text is transmitted to the client.

In operation S619, the text and the expression are transmitted to the client.

After operation S607, operation S610, operation S613, operation S616, and operation S619, operation S620 of displaying the icon, the pattern, the text, and the performance expression by the client based on the configuration table data is performed.

After operation 619, only the text and the performance expression are displayed in operation 620.

Operation S621: Receive a clicking/tapping operation for the prompt information, and display detailed information.

For example, the principle and function of operation S621 have been described above, and details are not described herein again.

FIG. 4I is a ninth schematic diagram of a human-computer interaction interface according to an aspect of this disclosure. A round-based battle is performed between a PC 402A and an NPC 403A. Before the PC 402A releases a skill, prompt information 401I is displayed near the NPC 403A. The prompt information 401I is a text prompt with content of “Feel the wrath of thunderbolt”. The player analyzes and determines a to-be-released skill of the NPC based on the text prompt information, and then determines, based on an analysis result, a skill released by the PC.

In the aspects of this disclosure, the following effects can be implemented by displaying prompt information.

1. Through a prompt system, interaction between an NPC and a player is increased, so that the player can obtain more information in an interaction process, and a combat strategy of defeating the NPC through the prompt information improves human-computer interaction efficiency.

2. Challenge and enjoyment of fighting against an NPC are increased. Through the prompt system, a player may learn the difficulty of fighting in a next turn and be prepared, which may provide enjoyment of fighting to the player while improving the fighting challenge.

3. A sense of achievement of the player is increased. After reading the prompt information, the player uses the prompt information as a reference to make a plan, which may greatly increase a probability of defeating an NPC and greatly increase the sense of achievement of the player, thereby increasing a player retention rate of a game.

A structure of the interaction processing apparatus 455 for a virtual scene provided in the aspects of this disclosure implemented as a software module continues to be described below. In some aspects, as shown in FIG. 2, the software module in the interaction processing apparatus 455 for a virtual scene stored in the memory 450 may include: a display module 4551, configured to display a virtual scene on a human-computer interaction interface, the virtual scene including an NPC and a PC that interact in a round-based manner; the display module 4551 being configured to display prompt information related to a to-be-released skill of the NPC in response to currently being in a process of waiting to receive a skill triggering operation for the PC; and a skill release module 4552, configured to control, in response to the skill triggering operation for the PC, the PC to release a skill triggered by the skill triggering operation, the prompt information being used as reference information of the skill triggering operation.

In some aspects, a type of the prompt information is a direct prompt. The display module 4551 is configured to display first prompt information for indicating the to-be-released skill of the NPC, the first prompt information including at least an identifier of the to-be-released skill.

In some aspects, the display module 4551 is configured to: after displaying the first prompt information for indicating the to-be-released skill of the NPC, display a prompt control in response to a triggering operation for the first prompt information, and display detailed information of the to-be-released skill in the prompt control. The detailed information includes at least one of the following: a skill type of the to-be-released skill, an attribute parameter change caused by the to-be-released skill, a skill name, and virtual energy consumed by the to-be-released skill.

In some aspects, the type of the prompt information is a positive prompt. The display module 4551 is configured to display second prompt information including a plurality of skills, the plurality of skills including the to-be-released skill of and another skill possessed by the NPC, and the second prompt information including at least identifiers of the plurality of to-be-released skills.

In some aspects, the display module 4551 is configured to: after displaying the second prompt information including a plurality of skills, display a prompt control in response to a triggering operation for the second prompt information, and display detailed information of the to-be-released skill in the prompt control. The detailed information includes at least one of the following: skill types and skill names of the plurality of to-be-released skills.

In some aspects, the type of the prompt information is a negative prompt. The display module 4551 is configured to display third prompt information including at least one skill, the third prompt information being configured for indicating a skill that the NPC is not to release, and the third prompt information including a first icon of the at least one skill.

In some aspects, the display module 4551 is configured to: after displaying the third prompt information including at least one skill, display a prompt control in response to a triggering operation for the third prompt information, and display a second icon and a skill name of the at least one skill in the prompt control. A size of the second icon is greater than that of the first icon.

In some aspects, a type of the prompt information is an indirect prompt. The display module 4551 is configured to display fourth prompt information for characterizing a skill type of the to-be-released skill of the NPC, the fourth prompt information including at least an identifier of the skill type of the to-be-released skill.

In some aspects, a type of the prompt information is a text prompt. The display module 4551 is configured to display text prompt information for characterizing the to-be-released skill of the NPC.

In some aspects, the skill release module 4552 is configured to: before displaying the text prompt information for characterizing the to-be-released skill of the NPC, obtain configuration information of the to-be-released skill of the NPC, a type of the configuration information including at least one of the following: a skill name, a skill type, virtual energy consumed by a skill, and an attribute parameter change caused by the skill; query a skill text relationship table for text information corresponding to each piece of the configuration information based on the configuration information of the to-be-released skill, the skill text relationship table being configured to store a correspondence between different configuration information and pre-configured text information; and combine the found text information into the text prompt information of the to-be-released skill.

In some aspects, the skill release module 4552 is configured to: before displaying the prompt information related to the to-be-released skill of the NPC, obtain current environment information of the virtual scene, the current environment information including at least one of the following: an attribute parameter of the PC, a quantity of current rounds, an attribute parameter of the NPC, and a terrain of the virtual scene; invoke a behavior tree of the NPC based on the current environment information, to determine a skill associated with the current environment information, each leaf node of the behavior tree corresponding to a different skill of the NPC, and each selection node of the behavior tree being configured to determine a leaf node corresponding to the current environment information; and use the skill associated with the current environment information as the to-be-released skill of the NPC.

In some aspects, the skill release module 4552 is configured to: after using the skill associated with the current environment information as the to-be-released skill of the NPC, query a mapping relationship table for a current prompting manner corresponding to the NPC based on a personality type corresponding to the NPC, the mapping relationship table storing mapping relationships between different personality types and different prompting manners; and generate the prompt information related to the to-be-released skill of the NPC based on the current prompting manner and the to-be-released skill.

In some aspects, the display module 4551 is configured to generate first prompt information for indicating the to-be-released skill of the NPC when the current prompting manner is a direct prompt; generate second prompt information including a plurality of skills when the current prompting manner is a positive prompt, the plurality of skills including the to-be-released skill of and another skill possessed by the NPC; generate third prompt information including at least one skill when the current prompting manner is a negative prompt, the third prompt information being configured for indicating a skill that the NPC is not to release; generate fourth prompt information for characterizing a skill type of the to-be-released skill of the NPC when the current prompting manner is an indirect prompt; and generate text prompt information for characterizing the to-be-released skill of the NPC when the current prompting manner is a text prompt.

In some aspects, the display module 4551 is configured to: before displaying the prompt information related to the to-be-released skill of the NPC is displayed,
perform the operation of displaying the prompt information related to the to-be-released skill of the NPC in response to the PC meeting a first display condition, the first display condition including at least one of the following:
a difference between the attribute parameter of the NPC and the attribute parameter of the PC is greater than a pre-configured difference, and a type of the attribute parameter including at least one of the following: a remaining health point, remaining virtual energy, attack power, and a character level, the virtual energy being energy consumed for releasing a skill; a victory probability of the PC against the NPC is less than a first win rate threshold; and a historical victory probability of each of a plurality of PCs against the NPC is less than a second win rate threshold.

In some aspects, the display module 4551 is configured to: before displaying the prompt information related to the to-be-released skill of the NPC, perform the operation of displaying the prompt information related to the to-be-released skill of the NPC in response to the virtual scene meeting a second display condition. The second display condition includes at least one of the following:
a terrain in which the PC is located in the virtual scene is at a disadvantage compared to the NPC; a distance between the PC and the NPC in the virtual scene is greater than a distance threshold; and the virtual scene has a buff attribute for the attribute parameter of the NPC.

An aspect of this disclosure provides a computer program product, the computer program product including a computer program or a computer-executable instruction, the computer program or the computer-executable instruction being stored in a computer-readable storage medium. A processor of an electronic device reads the computer-executable instruction from the computer-readable storage medium. The processor executes the computer-executable instruction, so that the electronic device performs the interaction processing method for a virtual scene provided in the aspects of this disclosure.

An aspect of this disclosure provides a computer-readable storage medium, such as a non-transitory computer-readable storage medium, having a computer-executable instruction or a computer program stored therein, the computer-executable instruction or a computer program, when executed by a processor, causing the processor to perform the interaction processing method for a virtual scene provided in the aspects of this disclosure, for example, the interaction processing method for a virtual scene shown in FIG. 3A.

In some aspects, the computer-readable storage medium may be a memory such as a ferromagnetic RAM (FRAM), a ROM, a programmable ROM (PROM), an erasable PROM (EPROM), an electrically EPROM (EEPROM), a flash memory, a magnetic surface memory, a compact disc, or a compact disc ROM (CD-ROM), or may be various devices including one or any combination of the foregoing memories.

In some aspects, the computer-executable instruction may be written in any form of a programming language (including a compiled or interpreted language, or a declarative or procedural language) in the form of a program, software, a software module, a script, or code, and may be deployed in any form, which may be deployed as a standalone program or as a module, components, a subroutine, or other units suitable for use in a computing environment.

In an example, the computer-executable instruction may but may not necessarily correspond to a file in a file system, may be stored in a part of the file for storing other programs or data, for example, stored in one or more scripts in a hypertext markup language (HTML) document, stored in a single file specially used for the discussed program, or stored in a plurality of collaborative files (for example, files storing one or more modules, a subprogram, or a code part).

In an example, the executable instruction may be deployed to be executed on one electronic device, or executed on a plurality of electronic devices located at one location, or executed on a plurality of electronic devices distributed at a plurality of locations and connected through a communication network.

Based on the above, in the aspects of this disclosure, during the round-based interaction, before the player releases a skill, prompt information related to a to-be-released skill of the NPC is displayed, and the prompt information is used as reference information for the PC to release the skill, so that the player decides the skill to be released by the PC, thereby improving interaction efficiency in the virtual scene, and saving computing resources required by the virtual scene. In this way, operation difficulty of a user is reduced, and then user experience is improved.

The foregoing descriptions are merely some examples of aspects of this disclosure and are not intended to limit the scope of this disclosure. Any modification, equivalent replacement, or improvement made within the spirit and principle of this disclosure falls within the scope of this disclosure.

What is claimed is:

1. An interaction processing method for a virtual scene, the method comprising:
displaying the virtual scene and a graphical user interface, the virtual scene including a non-player character (NPC) and a virtual character of a turn-based game;
displaying, by processing circuitry, notification information that includes NPC skill information associated with an NPC skill of the NPC that is to be performed in a next turn of the NPC in the turn-based game, the notification information being displayed during a turn of the virtual character that precedes the next turn of the NPC and in which a skill triggering operation for the virtual character is to be performed by a user; and
controlling the virtual character to perform a triggered skill based on the skill triggering operation for the virtual character.

2. The method according to claim 1, wherein the NPC skill information includes at least an identifier of the NPC skill.

3. The method according to claim 2, further comprising:
displaying detailed information of the NPC skill in response to a triggering operation being performed on the notification information, wherein
the detailed information includes at least one of a skill type of the NPC skill, an attribute parameter change caused by the NPC skill, a skill name of the NPC skill, and a virtual resource consumed by the NPC skill.

4. The method according to claim 1, wherein the displaying the notification information comprises:
displaying first NPC skill information associated with a first NPC skill for the NPC that is to be performed in the next turn of the NPC in the turn-based game and second NPC skill information associated with a second NPC skill of the NPC that is not to be performed in the next turn of the NPC in the turn-based game.

5. The method according to claim 4, further comprising:
displaying detailed information of the first NPC skill and the second NPC skill based on a triggering operation being performed on the notification information, wherein
the detailed information includes at least one of skill types and skill names of the first NPC skill and the second NPC skill.

6. The method according to claim 1, wherein the displaying the notification information comprises:
displaying third NPC skill information associated with a third NPC skill of the NPC that will not be performed in the next turn of the NPC in the turn-based game.

7. The method according to claim 6, further comprising:
displaying detailed information of the third NPC skill based on a trigger operation being performed on the notification information, the detailed information including an icon and a skill name of the third NPC skill.

8. The method according to claim 1, wherein the displaying the notification information comprises:
displaying skill type information characterizing a skill type of the NPC skill, the skill type information including at least an identifier of the skill type.

9. The method according to claim 1, wherein the displaying the notification information comprises:
displaying text information characterizing the NPC skill.

10. The method according to claim 9, further comprising:
obtaining configuration information of the NPC skill, the configuration information including at least one of a skill name, a skill type, a virtual resource consumed by the NPC skill, and an attribute parameter change caused by the NPC skill;
determining the text information by querying a skill text relationship table based on the configuration information, the skill text relationship table including correspondences between different configuration information and pre-configured text information.

11. The method according to claim 1, further comprising:
obtaining current environment information of the virtual scene, the current environment information including at least one of an attribute parameter of the virtual character, a quantity of current rounds, an attribute parameter of the NPC, and a terrain of the virtual scene;
invoking a behavior tree of the NPC based on the current environment information to determine a skill associated with the current environment information, each leaf node of the behavior tree corresponding to a different skill of the NPC, and each selection node of the behavior tree determining a leaf node corresponding to the current environment information; and
designating the skill associated with the current environment information as the NPC skill.

12. The method according to claim 11, further comprising:
querying a mapping relationship table for a current notification type corresponding to the NPC based on a personality type corresponding to the NPC, the mapping relationship table including mapping relationships between different personality types and different notification types; and
generating the notification information based on the current notification type and the NPC skill.

13. The method according to claim 12, wherein the generating the notification information comprises:
generating first notification information indicating the NPC skill when the current notification type is a direct notification;
generating second notification information including a plurality of NPC skills when the current notification type is a positive notification, the plurality of NPC skills including the NPC skill and at least one other NPC skill;
generating third notification information including information for an NPC skill that will not be performed in the next turn when the current notification type is a negative notification;
generating fourth notification information characterizing a skill type of the NPC skill when the current notification type is an indirect notification; and
generating text notification information characterizing the NPC skill when the current notification type is a text notification.

14. The method according to claim 1, further comprising:
determining whether the virtual character meets a first display condition; and
displaying the notification information when the virtual character meets the first display condition, wherein
the first display condition includes at least one of:
a difference between an attribute parameter of the NPC and a corresponding attribute parameter of the virtual character is greater than an attribute parameter threshold, and the attribute parameter including at least one of a remaining health point, remaining virtual resource, attack power, and a character level, the virtual resource being a resource consumed for performing a skill;
a victory probability of the virtual character against the NPC is less than a first win rate threshold; and
a historical victory probability of a plurality of virtual characters against the NPC is less than a second win rate threshold.

15. The method according to claim 1, further comprising:
determining whether the virtual scene meets a second display condition;
displaying the notification information when the virtual scene meets the second display condition,
the second display condition including at least one of:
a terrain of the virtual character is at a disadvantage compared to a terrain of the NPC;
a distance between the virtual character and the NPC in the virtual scene is greater than a distance threshold; and
the virtual scene provides a buff attribute for the NPC.

16. The method according to claim 1, wherein a skill release sequence between the virtual character and the NPC includes one of:
the virtual character performing a skill before the NPC performs a skill in one round; and
the virtual character performing a skill after the NPC performs a skill in one round.

17. An interaction processing apparatus, the apparatus comprising:
processing circuitry configured to:
display a virtual scene and a graphical user interface, the virtual scene including a non-player character (NPC) and a virtual character of a turn-based game;
display notification information that includes NPC skill information associated with an NPC skill of the NPC that is to be performed in a next turn of the NPC in the turn-based game, the notification information being displayed during a turn of the virtual character that precedes the next turn of the NPC and in which a skill triggering operation for the virtual character is to be performed by a user; and
control the virtual character to perform a triggered skill based on the skill triggering operation for the virtual character.

18. The apparatus according to claim 17, wherein the NPC skill information includes at least an identifier of the NPC skill.

19. The apparatus according to claim 18, wherein
the processing circuitry is configured to display detailed information of the NPC skill in response to a triggering operation being performed on the notification information; and
the detailed information includes at least one of a skill type of the NPC skill, an attribute parameter change caused by the NPC skill, a skill name of the NPC skill, and a virtual resource consumed by the NPC skill.

20. A non-transitory computer-readable storage medium storing instructions which, when executed by a processor, cause the processor to perform:
displaying a virtual scene and a graphical user interface, the virtual scene including a non-player character (NPC) and a virtual character of a turn-based game;
displaying notification information that includes NPC skill information associated with an NPC skill of the NPC that is to be performed in a next turn of the NPC in the turn-based game, the notification information being displayed during a turn of the virtual character that precedes the next turn of the NPC and in which a skill triggering operation for the virtual character is to be performed by a user; and
controlling the virtual character to perform a triggered skill based on the skill triggering operation for the virtual character.
